(19) United States
(12) Patent Application Publication
(10) Pub. No.: US 2004/0100032 A1
(43) Pub. Date: May 27, 2004

(54) Pneumatic suspension assembly

(76) Inventors: Michael Webber, Buchholz (DE); Thomas Rolewicz, Hamburg (DE)

Correspondence Address: WILLIAM COLLARD, COLLARD & ROE, P.C., 1077 NORTHERN BOULEVARD, ROSLYN, NY, 11576, US

(21) Appl. No.: 10/311,494

(22) PCT Filed: Jun. 22, 2002
(86) PCT No.: PCT/DE02/01064

(51) Int. Cl. F16J 15/38

(52) U.S. Cl. 277/391

(57) ABSTRACT

The invention relates to a pneumatic-suspension assembly, consisting of at least one pair of pneumatic-suspension bellows (2), a cover (5) comprising a first connection area (6), a rolling piston and an external guide (10). The inventive pneumatic-suspension assembly is characterized in that a continuous pleated bearing (11) connects the cover (5) to the external guide (10) and surrounds the pneumatic suspension bellows (2), whereby the pleased bearing comprises the following components: a first retaining part (13), which is fixed together with the corresponding end of the bellows (12) to the cover (5) in the first connection area (6); a second retaining part (14), which encompasses at least one partial area of the outer surface of the eternal guide (10); and a system of pleats (1), which is located between the first and second retaining part (13, 14) and which comprises at least a first and a second pleat (15, 16) that run towards the interior of the assembly, forming at least one contraction (17). The pneumatic suspension bellows (2) are adapted to the contour of contraction and a supporting ring (18) sits inside the contraction

### DESCRIPTION

The invention relates to a pneumatic suspension assembly comprised of at least the following:

A pneumatic suspension bellows made of elastomeric material with two ends of the bellows that encloses an air chamber with an elastic volume, forming a loop;

a cover with a first connection area for the one end of the bellows;

a roll-off piston comprising a second connection area for the other end of the bellows and, furthermore, a roll-off surface for the loop; as well as

an external guide for the pneumatic suspension bellows.

A pneumatic suspension assembly of this type is widely used in motor vehicle building (passenger cars, utility and rail-borne vehicles), whereby reference is made in particular to the published patent document DE 100 01 018 A1.

In addition to the basic components of the construction specified above, the pneumatic suspension assembly may be equipped with a vibration damper (shock absorber) as well. Such a pneumatic suspension assembly is referred also as a pneumatic suspension leg. With respect to the prior art in this regard, reference is particular made to the following published patent documents: DE 195 08 980 C2; DE 197 53 637 A1; DE 198 26 480 A1; and DE 100 50 028 A1.

A pneumatic suspension leg in introduced in the laid-open patent document DE 100 50 028 A1 in connection with which an articulated structural component is mounted on the within the closer area where the pneumatic suspension bellows is tied to the cover. This structural component permits swivel movements namely with the formation of a second loop that substantially extends in the radial direction. The articulated structural component comprises in this connection a support bearing preferably extending all around, which consists of a material that assures, in addition to the joint function, a limitation of the expansion as well.

Now, within the framework of a further development, the problem on hand is to provide a pneumatic suspension assembly of the type specified above with or without the vibration damper in connection with which in addition to safe tying of the external guide to the cover, an extensive Cardan deflection is assured as well.

This problem is resolved according to the characterizing part of claim 1 in that a pleated beating extending all around connects the cover with the external guide and at the same time surrounds the pneumatic suspension bellows within this area of connection, whereby the pleated bearing is comprised of the following structural components:

A first retaining part that is secured within the first connection area jointly with the corresponding end of the bellows on the cover;

a second retaining part that solidly encompasses at least one partial area of the outer surface of the external guide; as well as

a system of pleats, which is arranged between the first and the second retaining parts and which comprises at least a first and a second pleat that extend toward the interior of the assembly, forming at least one contraction, whereby the pneumatic suspension bellows adapts itself to the contour of the contraction, and whereby, furthermore, a supporting ring sits inside the contraction.

Useful further developments of the invention are specified in claims 2 to 12.

The invention is explained in the following with the help of exemplified embodiments and by reference to schematic drawings, in which:

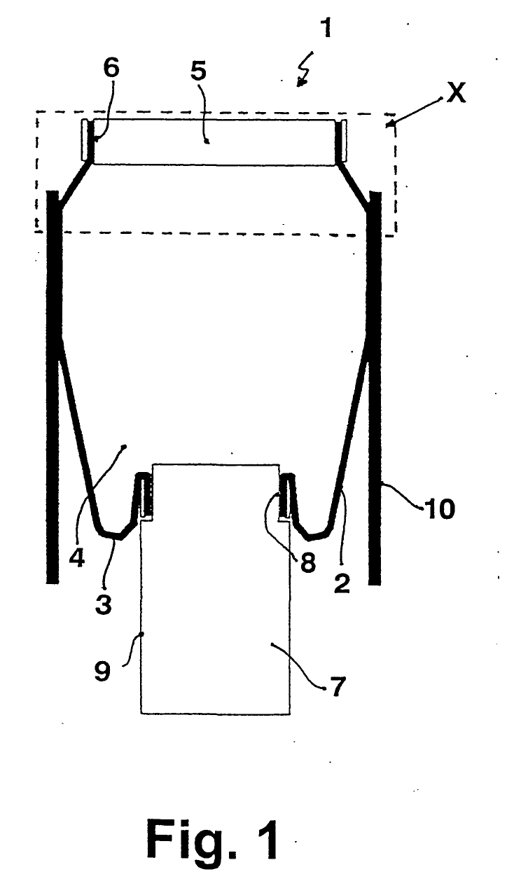

FIG. 1 shows a pneumatic suspension assembly with the basic structural components of the construction.

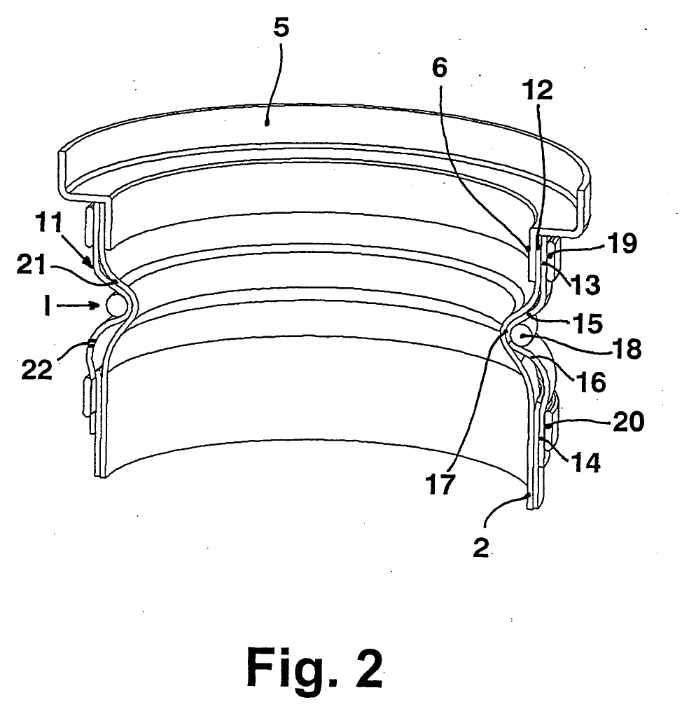

FIG. 2 shows a pleated bearing with two pleats and one contraction; and

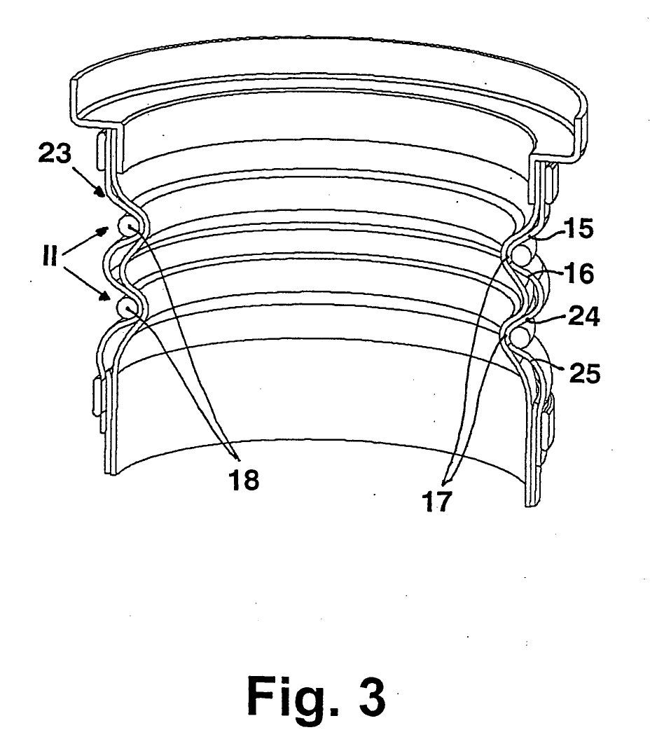

FIG. 3 shows a pleated bearing with four pleats and two contractions.

FIG. 1 shows a pneumatic suspension assembly 1 with the important basic structural components, namely the pneumatic suspension bellows 2; the cover 5 with possibilities for tying it to the body; the roll-off piston 7; and the external guide 10. The cover may be designed in the form of a pressure container in conjunction with a valve, if need be (DE 198 19 642 A1).

In most cases, the pneumatic suspension bellows 2 made of elastomeric material is provided with a reinforcement in the form of an axial bellows (DE 36 43 073 A1) or bellows with crossed layers (DE 29 04 522 A1). The two ends of the bellows are secured on the cover 5 and the roll-off piston 7 within the two connection areas 6 and 8, respectively, in particular by means of clamping rings. An air chamber 4 with an elastic volume is formed in this manner. During the contracting stroke, a loop 3 is formed that can slide along the roll-off surface 9. For protecting this loop, the pneumatic suspension assembly may be equipped with an additional protective sleeve. An external guide 10 supports the pneumatic suspension bellows, which is important especially when an axial bellows is used. The pneumatic suspension assembly with an external guide of the type as defined herein is therefore used also with an axial bellows in most cases.

The dashed area X, where the pleated bearing connects the cover 5 with the external guide 10, is now explained in greater detail in the following with the help of the two FIGS.2 and 3:

FIG. 2 shows a pleated bearing 11 extending all around that encloses the pneumatic suspension bellows 2 within the area of connection of the cover 5 (here with contouring) with the external guide 10, namely in the sense of a chambering. In this connection, the pleated bearing comprises the following structural components:

A first retaining part 13 that is secured on the cover 5 jointly with the corresponding bellows end 12 within the first connection area 6;

a second retaining part 14 that solidly encompasses at least one partial area of the outer surface of the external guide 10; as well as

a system of pleats 14, which is arranged between the first and the second retaining parts and comprises a first pleat 15 and a second pleat 16, said pleats extending directed inwardly, forming one single contraction 17, whereby the pneumatic suspension bellows 2 adapts itself to the contour of the contraction, and whereby, furthermore, a supporting ring 18 made of metal or plastic is seated inside the contraction. In the present case, the two pleats change into one another within the area of the contraction

The pleated bearing 11 consists of an elastomeric material or a thermoplastic elastomer in particular in connection with an embedded reinforcement, again in particular in the form of axially extending fiber reinforcements.

As an alternative to the above, the pleated bearing 11 may consist of a textile material preferably in the form of a fabric.

Within the first connection area 6, the first retaining part 13 of the pleated bearing and the corresponding bellows end 12 are secured on the cover by means of a common clamping ring 19.

The second retaining part 14 of the pleated bearing is secured on the external guide 10 by gluing and/or a clamping ring 20.

The pneumatic suspension bellows 2 and the pleated bearing 11 have a common contact surface 21 that is preferably free of adhesion, in particular in connection with at least one venting bore 22. It is useful in this connection if each pleat is provided with a venting bore.

FIG. 3 shows a pleated bearing 23 extending all around with a system of pleats II, which additionally comprises a third pleat 24 and a fourth pleat 25, whereby all four pleats extend substantially in a wavelike manner, namely with formation of the two contractions 17, whereby a supporting ring 18 is seated inside each contraction.

With respect to advantageous variations of the embodiment of the pleated bearing 23, reference is made to the pleated bearing 11 according to FIG. 2.

### List Of Reference Symbols

1 Pneumatic suspension assembly

2 Pneumatic suspension bellows

3 Loop (rolling pleat)

4 Air chamber with elastic volume

5 Cover (pressure container)

6 First connection area

7 Roll-off piston (immersion plunger)

8 Second connection area

9 Roll-off surface

10 External guide

11 Pleated bearing

12 End of bellows

13 First retaining part

14 Second retaining part

15 First pleat

16 Second pleat

17 Contraction

18 Supporting ring

19 Clamping ring

20 Clamping ring

21 Contact surface between pneumatic suspension bellows and pleated bearing

22 Venting bore

23 Pleated bearing

24 Third pleat

25 Fourth pleat

I System of pleats with two pleats

II System of pleats with four pleats

X Area of pleated bearing

1. A pneumatic suspension assembly (1) comprised of at least
a pneumatic suspension bellows (2) made of elastomeric material with two ends of the bellows encompassing an air chamber (4) with an elastic volume, forming a loop (3);
a cover (5) with a first connection area (6) for the one end of the bellows;
a roll-off piston (7) having a second connection area (8) for the other end of the bellows, and, furthermore, a roll-off surface (9) for the loop (3); as well as
an external guide (10) for the pneumatic suspension bellows (2);
characterized in that a pleated bearing (11, 23) extending all around connects the cover (5) with the external guide (10) and encompasses in this connection the pneumatic suspension bellows (2) within said area of connection, whereby the pleated bearing comprises the following structural components:
A first retaining part (13) secured within the first connection area (6) on the cover (5) together with the corresponding bellows end (12)
a second retaining part (14) solidly encompassing at least one partial area of the outer surface of the external guide (10); as well as
a system of pleats (I, II) arranged between the first and the second retaining parts (13, 14) and comprising at least a first and a second pleat (15, 16) extending directed inwards with formation of at least one contraction (17), whereby the pneumatic suspension bellows (2) adapts itself to the contour of the contraction, and whereby, furthermore, a supporting ring (18) is seated inside the contraction.

2. The pneumatic suspension assembly according to claim 1, characterized in that the system of pleats (I) is exclusively comprised of the first and the second pleat (15, 16) of one single contraction (17), whereby the two pleats change into one another within the area of the contraction in a curved manner.

3. The pneumatic suspension assembly according to claim 1, characterized in that the system of pleats (II) is additionally comprised of a third and a fourth pleat (24, 25), whereby all four pleats substantially extend in a wavelike manner, forming two contractions (17), whereby a supporting ring (18) is seated inside each contraction.

4. The pneumatic suspension assembly according to any one of claims 1 to 3, characterized in that the pleated bearing (11, 23) consists of an elastomeric material or a thermoplastic material.

5. The pneumatic suspension assembly according to claim 4, characterized in that the pleated bearing (11, 23) has an embedded reinforcement.

6. The pneumatic suspension assembly according to claim 5, characterized in that the reinforcement consists of axially extending fiber reinforcements.

7. The pneumatic suspension assembly according to claims 1 to 3, characterized in that the pleated bearing (11, 23) consists of a textile material preferably in the form of a fabric.

8. The pneumatic suspension assembly according to any one of claims 1 to 7, characterized in that the supporting ring (18) consists of metal or plastic.

9. The pneumatic suspension assembly according to any one of claims 1 to 8, characterized in that within the first connection area (6), the first retaining part (13) of the pleated bearing (11, 23) and the corresponding end (12) of the bellows are secured on the cover (5) by means of a common clamping ring (19).

10. The pneumatic suspension assembly according to any one of claims 1 to 9, characterized in that the second retaining part (14) of the pleated bearing (11, 23) are secured on the external guide (10) by means of gluing and/or a clamping ring (20).

11. The pneumatic suspension assembly according to any one of claims 1 to 10, characterized in that the pneumatic suspension bellows (2) and the pleated bearing (12, 23) have a common contact surface (21), the latter being free of adhesion.

12. The pneumatic suspension assembly according to any one of claims 1 to 11, characterized in that the pleated bearing (11, 23) has at least one venting bore (22).
